(19) United States
(12) Patent Application Publication
(10) Pub. No.: US 2009/0172750 A1
(43) Pub. Date: Jul. 2, 2009

(54) Distributed Media Management Apparatus and Method

(75) Inventor: Erik Scheelke, Cupertino, CA (US)

Correspondence Address: Carlineo, Spicer & Kee, LLC, 2003 S. Easton Road, Suite 208, Doylestown, PA, 18901, US

(73) Assignee: Resource Consortium Limited

(21) Appl. No.: 12/396,669

(22) Filed: Mar. 3, 2009

Related U.S. Application Data
(63) Continuation of application No. 10/846,189, filed on May 14, 2004, now abandoned.
(60) Provisional application No. 60/470,744, filed on May 14, 2003.

(51) Int. Cl. G06F 15/16; H04N 5/00; H04N 7/18

(52) U.S. Cl. 725/81; 386/126; 725/78; 709/206; 709/227

(57) ABSTRACT

An apparatus and method of distributing media content from a plurality of source devices to a plurality of remotely located display devices within a home network. A first management unit is assigned to control a first source stream and first display stream. A second management unit is assigned to control a second source stream and a second display stream. The first source stream and the first display stream are subsequently assigned to the second management unit if the first management unit fails. Alternatively, the second source stream and the second display stream are subsequently assigned to the first management unit if the second management unit fails. The apparatus and method can include a plurality of management units, each unit assigned to control at least one of the source streams and one of the display streams.

### RELATED APPLICATIONS

This application is a Continuation of U.S. patent application Ser. No. 10/846,189, filed May 14, 2004, and entitled Distributed Media Management Apparatus and Method, which claims the benefit of U.S. Provisional Patent Application No. 60/470,744, filed May 14, 2003, and entitled Distributed Media Management, the entire disclosures of which are incorporated herein by reference.

### FIELD OF THE INVENTION

The present invention relates generally to content distribution in a home network. More specifically, the present invention relates to a method and apparatus for managing and distributing media content from a plurality of source devices to a plurality of remotely located display devices within a home network.

### BACKGROUND OF THE INVENTION

There are numerous media services which provide scheduled programs on a viewing device, such as a television set. There are standard broadcast services which provide channels that can be received by virtually any television tuner through an antenna connector. There are cable services which typically offer packages of preselected channels to consumers and that require a decoder at the television tuner or on the cable line at an external location. Cable services continuously broadcast scheduled programming through a preselected set of channels which are received through a cable connector on a television set. There are also a number of pay-per-view services which allow customers to receive scheduled one time program transmissions through the cable network. Other available services include satellite programming which allow consumers to select on demand pay-per-view programs from a set of available programs.

Modern home entertainment systems have available a plurality of electronic devices for display or playback of audio and video programs. Examples include video laser disc players, video cassette recorders (VCRs'), compact disc (CD) players, and similar media sources. These media sources typically output onto television LCD panels, computers, stereo receivers and other output devices.

Users increasingly expect delivery of these media sources and programming services anywhere at any time and desire a convenient system to select media offered from a plurality of content providers. As the number of interoperable electronic devices in the home environment increases, the need arises for a way to distribute media content from a media source device to a remotely located media display device and to allow the devices to interact remotely, such as displaying the output of a DVD player located in a living room on a television located in a bedroom separated by one or more walls.

Most prior art schemes that distribute media content within a home network are relegated to simply downloading digital content off the Internet and displaying it on a personal computer. This scheme restricts access to other media content sources located in the home or to devices that connect the home to external access networks, including TVs, VCRs, set-top boxes, video game consoles and other audio/video devices.

A problem encountered when attempting to distribute analog signals from legacy hardware input sources, such as a DVD player, to remotely located legacy hardware output sources, such as a TV located in a different room, is that the input sources need to be directly connected to the output sources. This configuration limits utilization of input sources and requires additional wiring and components. Legacy hardware switch devices, such as receivers and tuners, can provide switching of media signals. However, these devices work only in an analog domain and are generally limited to devices in close geographic proximity to the switch. Thus these switches do not offer a way to distribute the media content to all areas of the home.

What is needed is a method of and apparatus for distributing media content from a plurality of source devices to a plurality of remotely located display devices within a home network utilizing a plurality of management units.

### SUMMARY OF THE INVENTION

The present invention discloses an apparatus and method of distributing media content from a plurality of source devices to a plurality of remotely located display devices within a home network. The present invention utilizes a plurality of management units to couple media source devices such as DVD players, CD players, cable/satellite receivers and other content sources with media display devices such as televisions and display screens, utilizing a home network as a conduit for the content distribution. The present invention overcomes the drawbacks of requiring additional wiring and components to connect input devices with output devices. The present invention also overcomes the drawbacks of using legacy hardware switch devices, such as receivers and tuners, to provide switching of media signals.

In accordance with one embodiment of the present invention, an apparatus for managing and distributing media content from a plurality of source devices to a plurality of remotely located display devices within a home network, is disclosed. The apparatus comprises a first management unit assigned to control a first source stream and a first display stream. The apparatus also comprises a second management unit assigned to control a second source stream and a second display stream, wherein the first source stream and the first display stream are subsequently assigned to the second management unit if the first management unit fails. Alternatively, the second source stream and the second display stream are subsequently assigned to the first management unit if the second management unit fails.

The apparatus can comprise a third management unit assigned to control a third source stream and a third display stream. The third source stream and the third display stream can be subsequently assigned to one of the first management unit and the second management unit if the third management unit fails.

The apparatus can further comprise a plurality of management units, each management unit assigned to control at least one of the source streams and one of the display streams. One of the plurality of management units can be assigned to control each source stream and each display stream if all other of the plurality of management units fail. Preferably, the source streams and the display streams originate in locations remote from each other. Preferably, each source device is associated with one source stream and each display device is associated with one display stream.

Each management unit must “publish” the operations (controls) being undertaken by means of at least one communication channel between the management units. If, for example, the second management unit does not detect a “publication” from the first management unit in a specified amount of time, a failure occurs and the second management unit takes over the operations and controls the requests from a user, with no or minimal interruption perceivable by the user. Thus, the management units can monitor each other's operations in real time and perform “hand-offs” during a failure.

The home network can be a local area network (LAN). The home network can also be a wide area network (WAN). The home network can also be a cable network. Preferably, the home network is a digital network. The digital network can be wireless. The digital network can also be wired. Alternatively, the digital network can be a powerline.

The source devices can be at least one of a DVD player, a CD player, a laser disc player a VCR, a cable receiver and a satellite receiver. The display devices can be at least one of a television, a computer, a stereo receiver, and a display screen. The source devices can include means for establishing a direct transmissions link with each display device for distribution of the media content if the management units fail.

In accordance with another embodiment of the present invention, a method of managing and distributing media content from a plurality of source devices to a plurality of remotely located display devices within a home network, is disclosed. The method comprises the steps of assigning to a first management unit control of a first source stream and first display stream. The method also comprises the step of assigning to a second management unit control of a second source stream and a second display stream. The method further comprises the step of subsequently assigning to the second management unit control of the first source stream and the first display stream if the first management unit fails. The method can include the step of subsequently assigning to the first management unit control of the second source stream and the second display stream if the second management unit fails. The method can also include the step of assigning to a third management unit control of a third source stream and a third display stream. The method can also include the step of assigning to a plurality of management units each control of at least one of the source streams and at least one of the display streams.

### BRIEF DESCRIPTION OF THE DRAWINGS

FIG. 1 shows an apparatus for managing and distributing media content from a plurality of source devices to a plurality of remotely located display devices, within a home network, in accordance with the present invention.

FIG. 2 is a block diagram of an apparatus for managing and distributing media content from a plurality of source devices to a plurality of remotely located display devices, within a home network, in accordance with the present invention.

FIG. 3 is a flow chart illustrating a method of managing and distributing media content from a plurality of source devices to a plurality of remotely located display devices, in a home network, in accordance with the present invention.

### DETAILED DESCRIPTION OF A PREFERRED EMBODIMENT

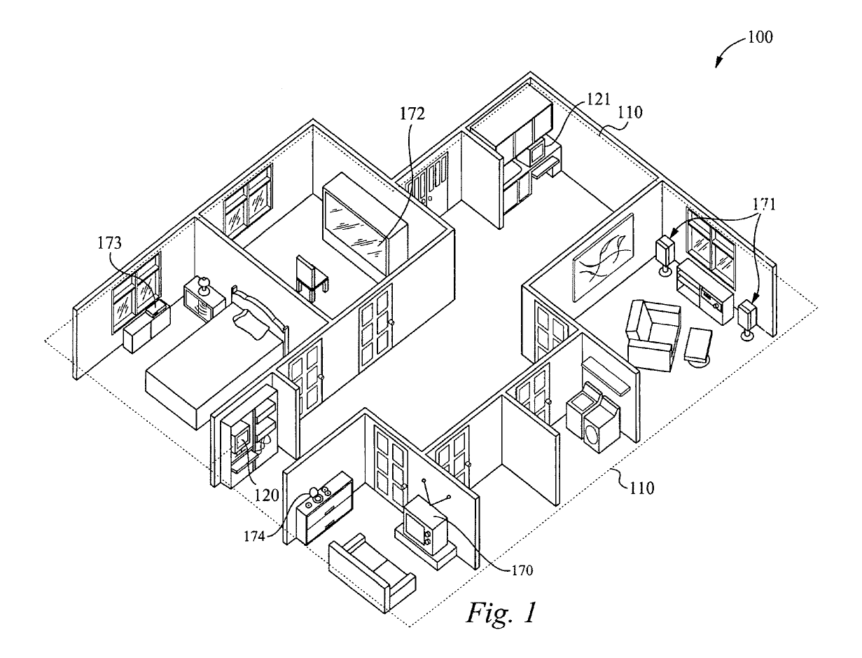

FIG. 1 illustrates one embodiment of an apparatus 100 for managing and distributing media content from a plurality of source devices to a plurality of remotely located display devices, within a home network, in accordance with one embodiment of the present invention. The apparatus 100 includes a network 110, a first management unit 120, a second management unit 121, source devices 173 and 174, and display devices 170, 171 and 172. Each source device 173 and 174 is associated with a source stream. Each display device 170-172 is associated with a display stream. The source device 173, for example, is a DVD player. The source device 174 is a CD player. The display device 170 is a television. The display device 171 is a speaker system. The display device 172 is a television. The source devices 173 and 174 can be any source device, including a cable receiver and a satellite receiver. Similarly, the display devices 170-172 can be any display device, including a display screen. In this embodiment, the devices 170-174 are separated by one or more walls. The network 110 is preferably a digital network. The network 110 can also be a local area network (LAN), a wide area network (WAN), or a cable network. The digital network can be wireless. Alternatively, the digital network can be wired. The digital network can also be a powerline.

The management units 120 and 121 manage the distribution of the source streams and the display streams. The management units 120 also couple the source device 173 and 174 with the display devices 170-172 utilizing the network 110 as a conduit for content distribution. In one embodiment, each management unit 120 and 121 can be assigned to control at least one source stream and at least one display stream. In FIG. 1, for example, the management unit 120 can be assigned to control the source stream associated with the DVD player 173 and the display streams associated with the televisions 170 and 172. In one embodiment, the management unit 121 can be assigned to control the source stream associated with the CD player 174 and the display stream associated with the stereo speakers 171. Thus, if a user requests to play a DVD in the DVD player 173 to be displayed on the television 172, which is located remotely from the DVD player 173, the management unit 120 can be assigned to control both the source stream from the DVD player 173 and the display stream to the television 172. Further, if the user requests to play a CD in the CD player 174 on the stereo speakers 171, the management unit 121 can be assigned to control both the source stream from the CD player 174 and the display stream to the stereo speakers 171. Also, a user or users can request to play the DVD on each television 170 and 172 simultaneously with the management unit 120 controlling both display streams to the televisions 170 and 172 and the source stream from the DVD player 173.

In accordance with the present invention, each management unit 120 and 121 must “publish” the operations (controls) being undertaken by means of at least one communication channel between the management units 120 and 121. If, for example, the management unit 121 does not detect a “publication” from the management unit 120 in a specified amount of time, a failure occurs and the management unit 121 takes over the operations and controls the requests Sum a user, with no or minimal interruption perceivable by the user. Thus, the management units 120 and 121 can monitor each other's operations in real time and perform “hand-offs” during a failure.

A novel feature of the present invention includes the use of more than one management unit to manage the distribution of media content. Each management unit can share storage resources and work in concert to promote robustness and efficiency in delivering content to the user. More specifically and referring to FIG. 1, if the first management units 120 fails or is turned off, the second management unit 121 can take over and assume responsibility for distribution of the source and displays streams. Thus, in our previous example where the first management unit 120 controls the source streams of the DVD player 173 and the display streams of the televisions 170 and 172, if the first management unit 120 fails, the second management unit 121 can assume control of not only the CD player 174 and the stereo speakers 171 but also the DVD player 173 and the televisions 170 and 172. Likewise, if the second management 121 fails, the first management unit 120 can assume control of not only the DVD player 173 and the televisions 170 and 172 but also the CD player 174 and the stereo speakers 171. Further, in a home network having more than two management units, if one (or more) of the management units fail, any other management unit can take over and assume responsibility of the source and display devices previously controlled by the failed management unit.

Another novel feature of the present invention includes the capability of the source devices to distribute content directly to the display devices without sending the content through one of the management units. The management units can continue to control each unit, but the content would flow directly from device to device without impacting the network. For example and referring still to FIG. 1, the DVD player 173 can send its content directly to the television 172 along a signal bus (not shown) that is coupled to each device 170-174 and without sending the content through the management unit 120.

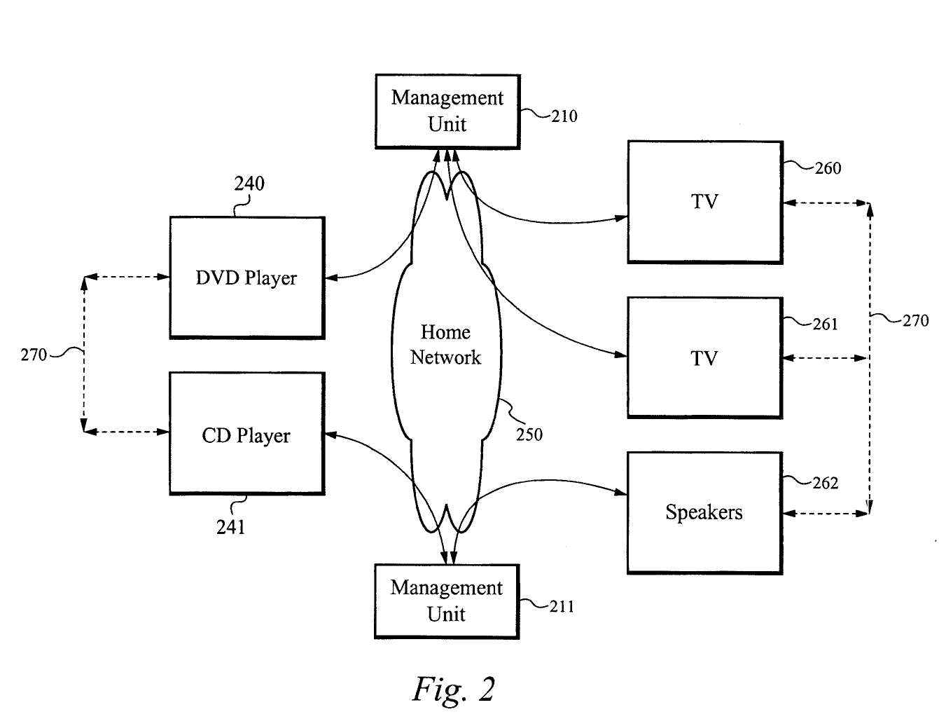

FIG. 2 is a block diagram of an apparatus 200 for managing and distributing media content from a plurality of source devices to a plurality of remotely located display devices, within a home network, in accordance with one embodiment of the present invention. The apparatus 200 includes a network 250, first management unit 210, a second management unit 211, a DVD player 240, a CD player 241, a TV 260, a TV 261, speakers 262 and a signal bus 270. In this embodiment, the first management unit 210 is assigned to control a source stream of the DVD player 240, a display stream of the TV 260 and a display stream of the TV 261. The second management unit 211 is assigned to control a source stream of the CD player 241 and a display stream of the speakers 262. Each source stream is transmitted through the network 250. Each display stream is received through the network 250. The signal bus 270 couples each source device 240 and 241 and each display device 260-262, and allows the source devices 240 and 241 to transmit the source streams directly to the display devices 260-262 without sending the streams through the management units 210 and 211. The management units 210 and 211 can continue to control each device 240,241 and 260-262, but the content flows directly from device to device through the signal bus 270 without any impact on the network 250.

In accordance with the present invention, each management unit 210 and 211 must “publish” the operations (controls) being undertaken by means of at least one communication channel between the management units 210 and 211. If, for example, the management unit 211 does not detect a “publication” from the management unit 210 in a specified amount of time, a failure occurs and the management unit 211 takes over the operations and controls the requests from a user, with no or minimal interruption perceivable by the user. Thus, the management units 210 and 211 can monitor each other's operations in real time and perform “hand-offs” during a failure. As an example of how the present invention can be performed, in accordance with one embodiment of the present invention and FIG. 2, if a user requests to play a DVD in the DVD player 240 on a remotely located display device, such as the television 260, the user sends a command signal to one of the management units 210 and 211 using a wireless remote, instructing the management units 210 and 211 to play the DVD on the television 260. The management unit 210, which in this example is assigned to control the DVD player 240 and the television 260, sends a signal to the DVD player 240 to transmit its source stream to the management unit 210. The management unit 210 also sends a signal to the television 260 to start displaying the stream it is receiving from the DVD player 240 through the management unit 210 and the network 250. The DVD player 240 plays the DVD and sends its audio and video streams through the network 250 to the management unit 210. The management unit 210 receives the source stream and then transmits the stream through the network 250 to the television 260 to be displayed. If the management unit 210 fails at any time during the transmission or display of the stream, the management unit 220 can take over and assume responsibility for the distribution and management of the DVD player 240 and the television 260, even if the management unit 220 is currently managing other source devices and other display device. Further, the DVD player can transmit its content directly to the television 260 via the signal bus 270 without sending the content through any of the management units 210 and 220.

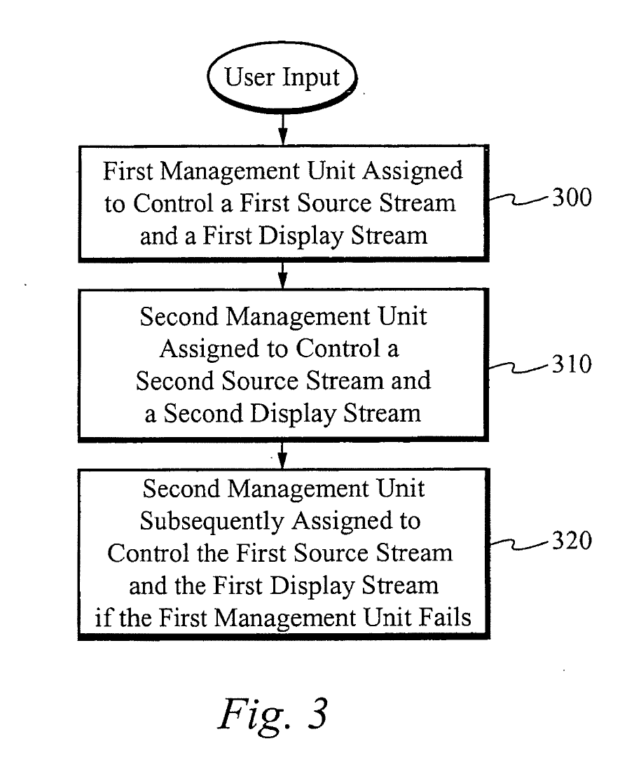

FIG. 3 is a flow chart illustrating a method of managing and distributing media content from a plurality of source devices to a plurality of remotely located display devices, in a home network, in accordance with the present invention. In the step 300, after a user requests to play a media content on a remotely located display device, a first management unit is assigned to control a first source stream and a first display stream. In the step 310, a second management unit is assigned to control a second source stream and a second display stream. In the step 320, the second management unit is subsequently assigned to control the first source stream and the first display stream if the first management unit fails. Alternatively, the first management unit can be assigned to control the second source stream and the second display stream if the second management unit fails. The method can also include a the step of assigning a third management unit to control a third source stream and a third display stream. If the third management unit fails, the third source stream and the third display stream can be assigned to one of the first management unit and the second management unit. Each management unit must “publish” the operations (controls) being undertaken by means of at least one communication channel between the management units. If, for example, the second management unit does not detect a “publication” from the first management unit in a specified amount of time, a failure occurs and the second management unit takes over the first management unit's operations and controls the requests from a user, with no or minimal interruption perceivable by the user. Thus, the management units can monitor each other's operations in real time and perform “hand-offs” during a failure. Also, the method can include a plurality of management units where each unit is assigned to control at least one of the source streams and one of the display streams. Further, the source devices can include means for establishing a direct transmissions link with each display device for distribution of the media content if the management unit fails.

This invention has been described in terms of specific embodiments incorporating details to facilitate the understanding of the principles of construction and operation of the invention. Such reference herein to specific embodiments and the details thereof is not intended to limit the scope of the claims appended hereto. It will be apparent to those of ordinary skill in the art that modifications can be made in the embodiment chosen for illustration without departing from the spirit and scope of the invention.

What is claimed is:

1. A method of providing failover in a streaming media system, the method comprising:
(a) receiving, by a secondary management computer, a first publication message indicating that a primary management computer is controlling a source media stream and a display media stream;
(b) determining, by the secondary management computer, that a predefined period has elapsed since the first publication message was received; and
(c) sending, by the secondary management computer, a second publication message indicating that the secondary management computer is controlling the source media stream and the display media stream.

2. The method of claim 1, wherein the source media stream is associated with a source media device selected from a group comprising a computer, a DVD player, a CD player, a VCR, a cable receiving, a television receiver, and a satellite receiver.

3. The method of claim 1, wherein the display media stream is associated with a display media device selected from a group comprising a television, a computer, a stereo receiver, and a display screen.

4. The method of claim 1, wherein the first publication message is received over a digital network.

5. The method of claim 4, wherein the digital network is wired.

6. The method of claim 4, wherein the digital network is wireless.

7. The method of claim 1, wherein the secondary management computer controls a plurality of source media streams and a plurality of display media streams.

8. A method of providing failover in a streaming media system, the method comprising:
(a) receiving, by a source media device, a request for a media stream, wherein the request comprises a management computer address and a display media device address;
(b) transmitting, by the source media device, the media stream over a first network to the management computer address;
(c) determining, by the source media device, that the management computer cannot receive the media stream; and
(d) redirecting, by the source media device, the media stream to transmit over a second network to the display media device address.

9. The method of claim 8, wherein the source media device address is selected from a group comprising a computer, a DVD player, a CD player, a VCR, a cable receiver, a television receiver, and a satellite receiver.

10. The method of claim 8, wherein the display media device address is associated with a display media device selected from a group comprising a television, a computer, a stereo receiver, and a display screen.

11. The method of claim 8, wherein the first network a digital network.

12. The method of claim 11, wherein the digital network is wired.

13. The method of claim 11, wherein the digital network is wireless.

14. The method of claim 8, wherein the second network is a digital network.

15. The method of claim 14, wherein the digital network is wired.

16. The method of claim 14, wherein the digital network is wireless.

17. A streaming media system for managing and distributing media content from a plurality of source media devices to a plurality of destination media devices, the system comprising:
(a) a plurality of management computers, configured to control a plurality of source media streams and a plurality of destination media streams;
(b) a first digital network connecting the management computers, the source media devices, and the destination media devices; and
(c) a second digital network connecting the source media devices and the destination media devices.

18. The system of claim 17, wherein the first digital network is wired and the second digital network is wireless.

19. The system of claim 17, wherein the first digital network is wireless and the second digital network is wired.

20. The system of claim 17, wherein at least one of the first digital network and the second digital network is a powerline network.
